(19) United States
(12) Patent Application Publication
(10) Pub. No.: US 2008/0243615 A1
(43) Pub. Date: Oct. 2, 2008

(54) ADVERTISING SYSTEM AND METHOD UTILIZING FLOOR MAT WITH RECESSED ADVERTISEMENT PANEL, AND METHOD OF DOING BUSINESS USING THE SAME

(76) Inventors: FRED POTOK, Huntington Valley, PA (US); Philip W. Still, LaGrange, GA (US)

Correspondence Address: COZEN O'CONNOR, P.C., 1900 MARKET STREET, PHILADELPHIA, PA, 19103-3508, US

(21) Appl. No.: 11/866,674

(22) Filed: Oct. 3, 2007

Related U.S. Application Data
(62) Division of application No. 11/225,700, filed on Sep. 13, 2005.

(51) Int. Cl. G06Q 30/00; B23P 11/00

(52) U.S. Cl. 705/14; 29/428

(57) ABSTRACT

A floor advertising method that utilizes a floor mat having a recessed area for receiving an advertising panel. In one aspect, the method uses a floor advertising system comprising: a floor mat having a bottom surface, a top surface, and a recessed area in the top surface, the recessed area having a depth; and a panel having an advertisement, the panel positioned in the recessed area. In some embodiments, it is preferred that the panel have a thickness that is substantially equal to or less than the depth of the recessed area. In another aspect, the invention is a method of doing business utilizing such a floor advertising system.

### CROSS REFERENCE TO RELATED APPLICATIONS

This application is a divisional of application Ser. No. 11/225,700, filed Sep. 13, 2005.

### FIELD OF THE INVENTION

The present invention relates generally to the field of advertising, and specifically to systems and methods of advertising on floor space.

### BACKGROUND OF THE INVENTION

Advertising has traditionally used signs or visual displays to convey product information to a consumer. Although visual displays are effective, there is a need for more effective advertising systems and methods of advertising that will attract consumers, hold their attention, and convince them to purchase the advertised product.

One particular field of advertising is the advertising of products within stores, including for example grocery stores, super markets, and retail stores. Traditionally, products were advertised in stores through the use of vertical signs or visual displays. Although such vertical signs were effective advertising tools, there is a particular need for new methods and systems of in-store advertising that will convince consumers to purchase various products.

One type of advertising that has recently become popular is so-called floor decals/mats, which are essentially signs that rest on or are adhered to the floor. The term “decal” and “mat” are used interchangeably throughout this application. Advertisers deem floor advertising beneficial because the floor decals can be located on the floor of a store proximal to the area in which a product is shelved. These floor decals also increase the advertising space that can be utilized in stores and public places.

While the general use of floor decals as an advertising means has been accepted over the years, existing systems and methods suffer from a number of disadvantages. For example, existing decals are of a unitary structure wherein the advertiser's message is built into or permanently painted on or secured to the decal itself. Thus, if the advertiser wishes to change their message/advertisement, or if the message/advertisement becomes worn over time, the entire floor decal must be replaced. Similar drawbacks arise when a new advertiser wishes to take over the floor space rented by another advertiser. Because floor decals can be costly to manufacture, replacing an entire decal for such purposes is undesirable. Thus, a need exists for a system and method of floor advertising that affords the user the ability to change the advertising message without replacing the entire floor decal.

An additional problem with existing floor decals is that they are designed for use on specific types of surfaces. As such, these floor decals can not be used safely on a variety of surfaces without presenting the danger of slipping. Still another problem is that existing floor decals often become dirty or worn in short periods of time due to heavy consumer traffic and, therefore, require additional maintenance and/or replacement.

### SUMMARY OF THE INVENTION

It is therefore an object of the present invention to provide an improved floor advertising system and method.

Another object of the present invention is to provide a floor advertising system and method that affords the user the ability to change the advertisement/message without replacing the entire floor decal/mat.

Still another object of the present invention is to provide a floor advertising system and method that can be safely used on a variety of floor surfaces.

Yet another object of the present invention is to provide a floor advertising system and method that is durable.

A further object of the present invention is to provide a floor advertising system and method that acts as a cleaning mat and/or protective floor covering for high traffic areas.

A still further object of the present invention is to provide a floor advertising system and method that is cost effective to maintain, update, and/or manufacture.

In one aspect, the invention is a method of advertising comprising: a) providing a floor mat having a bottom surface, a top surface, and a recessed area in the top surface, the recessed area having a depth; b) inserting a first panel having a first advertisement in the recessed area; and c) positioning the floor mat on a floor of a retail store. In one embodiment, this method can further include: d) removing the first panel having the first advertisement from the recessed area after a predetermined period of time; and e) inserting a second panel having a second advertisement in the recessed area. For the reasons discussed with the inventive system, in one embodiment, it may be preferable that the panels used in the inventive method of advertising have a thickness that is substantially equal to or less than the depth of the recessed area.

In another aspect, the invention is a method of doing business comprising: a) identifying a store having vacant floor space; b) paying the store a first amount of currency for rights to the vacant floor space; c) providing a floor mat having a bottom surface, a top surface, and a recessed area in the top surface, the recessed area having a depth, the floor mat having being of an area that fits within the vacant floor space; d) identifying an advertiser that desires to advertise in said store; e) charging the advertiser a second amount of currency to advertise on the vacant floor space of the store; f) providing a panel having an advertisement for the advertiser, the advertiser's products, and/or the advertiser's services; and g) positioning the floor mat on the vacant floor space of the store and inserting the panel into the recessed area of the floor mat. As discussed above, in one embodiment, the panel may have a thickness that is substantially equal to or less than the depth of the recessed area.

Moreover, in some embodiments of the aforementioned aspects of the invention, it may be preferable that the panels used substantially correspond in size and shape to the recessed area. This will prohibit sliding of the panel within the recessed area.

### BRIEF DESCRIPTION OF THE DRAWINGS

FIG. 1 is a perspective view of an advertising floor mat according to one embodiment of the present invention.

FIG. 2 is a perspective view of the advertising floor mat of FIG. 1 with the panel and lamina removed.

FIG. 3 is an exploded view of the advertising floor mat of FIG. 1.

FIG. 4 is a cross-sectional view of the advertising floor mat of FIG. 1 taken along line III-III.

FIG. 5 is a flow chart of a method of advertising according to one embodiment of the present invention.

FIG. 6 is a flow chart of a method of doing business according to one embodiment of the present invention.

### DETAILED DESCRIPTION

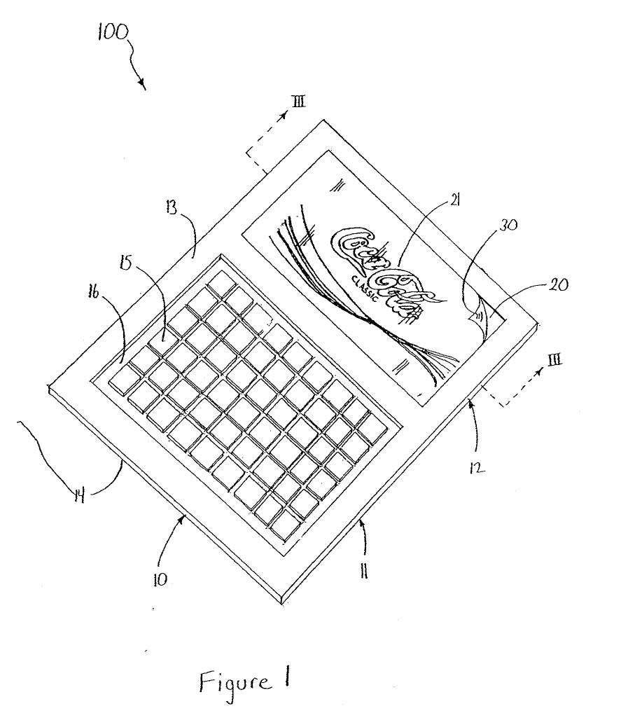

FIG. 1 illustrates a floor advertising system 100 according to one embodiment of the present invention. The floor advertising system 100 comprises a floor mat 10, a panel 20, and a lamina 30. Because the lamina 30 is substantially transparent, the top right corner of the lamina 30 is bent upward in the illustration so that its existence is visible. Normally, the entirety of the lamina 30 will lay flat atop the panel 20.

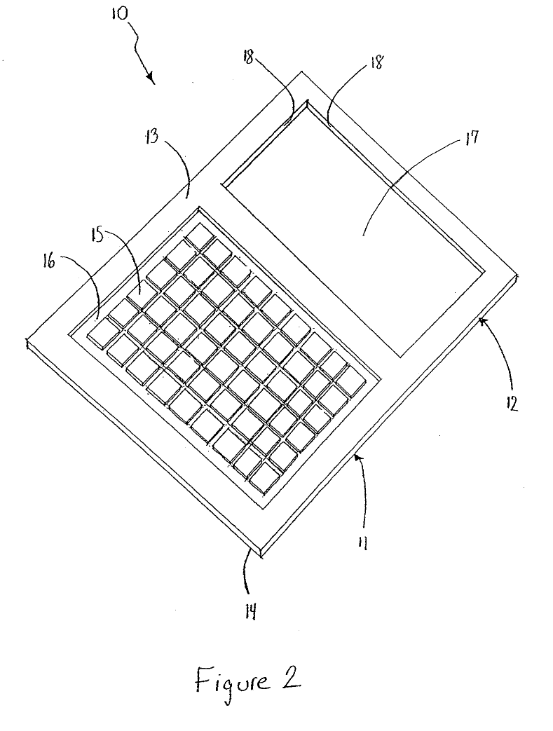

Referring now to FIG. 2, an embodiment of the floor mat 10 will be described in detail. For ease of illustration and description, the panel 20 and the lamina 30 have been removed from the illustration of the floor mat 10. In some embodiments, the floor mat 20 is preferably an all rubber bi-level construction. Suitable types of rubber for construction include, without limitation, nitrile butadiene rubber (“NBR”), styrene-butadiene rubber (“SBR”), Ethylene Propylene Diene Monomer (“EPDM”), Neoprene, chlorinated polyethylene (“CPE”), Natural rubber or various combinations of the above. NBR is preferred. The invention, however, is not limited to rubber or any particular material for construction of the floor mat 10. Other suitable materials of construction, include without limitation wood, metal, carpet, ceramic, natural, manmade, and recycled materials. Depending on the type of material used for construction, the floor mat 10 can be formed by injection molding, stamping, press-molding, milling, vacuum forming and autoclave.

The floor mat 10 comprises a top surface 13 and bottom surface 14. The top surface 13 (including the top surfaces of the scrapers 15) can be textured or otherwise roughened to increase the friction coefficient if desired. The same can be done to the bottom surface 14. Texturing or roughening the surfaces 13, 14 of the floor mat 10 helps prevent both unwanted slipping atop the floor mat 10 and/or unwanted shifting of the floor mat 10 on the floor. Other properties that can be built into the surfaces are static dissipative or conductive, antimicrobial, and antifatigue properties.

The floor mat 10 further comprises an advertising section 12 and, optionally, a scraper section 11. The scraper section 11 is provided to serve the function of removing dirt, dust, and other debris from the bottom of people's shoes or feet. The scraper section 11 comprises a plurality of scrapers 15 surrounded by a containment groove 16. In some embodiments, the top surface of the scrapers 15 can be substantially flush with the remaining top surface 13 of the floor mat 10. However, the scrapers 15 can be further raised if desired. The scrapers 15 act as ridges that scrape, rub, or otherwise knock debris loose from a person's shoes (or other objects) as they pass thereover. The containment groove 16 is a depressed trench that surrounds the scrapers 15. As a result, once debris is removed from a person's shoes or other objects by the scrapers 15, the debris remains trapped in the scraping section 11 of the floor mat 10 and will be prohibited from coming into contact with a person's shoes or other objects again.

While the scrapers 15 are exemplified as rectangular elements, the scrapers 15 can take on any shape, including, without limitation, circular, thatched, triangular, oval, pentagonal, hexaganol, octagonal, or irregularly shaped. In other embodiments, the scrapers can be in the form of ridges, grating, or a roughly textured surface. In other embodiments of the invention, the floor mat 10 may not even have a scraper section 11 and will merely consist of the advertising section 12 as described below.

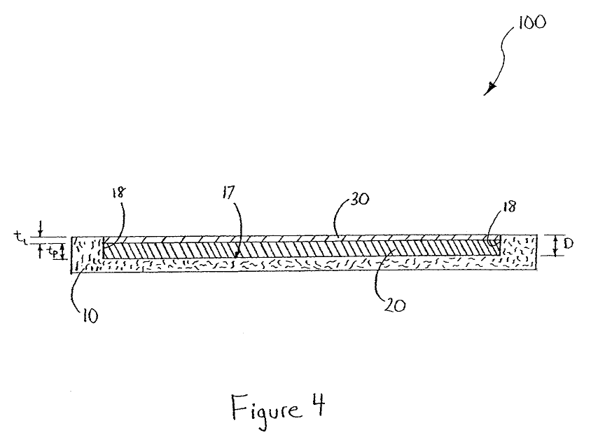

The advertising section 12 of the floor mat 10 comprises a recessed area 17. The recessed area 17 is exemplified as being rectangular in shape but can take on any shape, including, without limitation, circular, thatched, triangular, oval, pentagonal, hexaganol, octagonol, or irregularly shaped. The recessed area 17 is a depressed area in the top surface 13 of the floor mat 10. A containment ledge 18, which is naturally formed by the depressed nature of the recessed area 17, surrounds the entirety of the recessed area 17. In other embodiments of the invention, the containment ledge may only surround two or three sides of the recessed area 17, or may contain intermittent spaces. However, it is preferred that the containment ledge 18 fully surround the recessed area 17 so as to prohibit the panel 20 and lamina 30 from sliding out of the recessed area 17 when positioned therein as shown in FIG. 1. The depth of the recessed area 17 will be discussed in greater detail below with respect to FIG. 4.

While the advertising section 12 comprises a single recessed area 17, in other embodiments of the invention, a plurality of recessed areas can be provided in a single floor mat. In such an embodiments, a suitably sized advertising panel (and/or lamina) will be positioned in each recessed area in a manner similar to that described below for panel 20 and/or lamina 30.

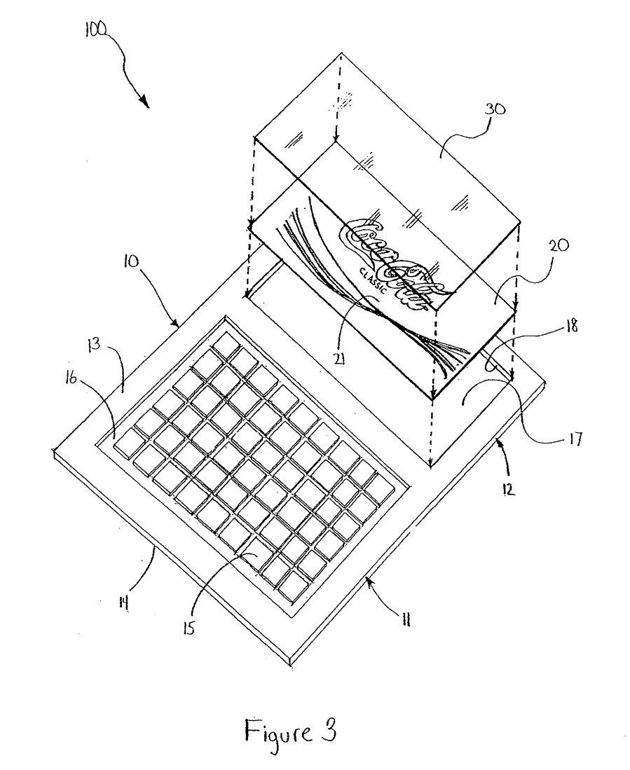

Referring now to FIG. 3, an exploded view of the floor advertising system 100 is illustrated. As mentioned above, the floor advertising system 100 comprises the floor mat 10, the panel 20, and the lamina 30. The panel 20 and the lamina 30 correspond in size and shape to the recessed area 17 so that they can be positioned snugly therein. The panel 20 comprises an advertisement 21 on its top surface. In the illustration, the advertisement 21 is for Coca-Cola®. However, the advertisement 21 can be anything and is not limited to any specific manufacturer or service provider and/or message. Moreover, if desired, the panel 20 can have an advertisement 21 on both sides of the panel 20. The advertisement on the back side of the panel 20 can be a identical to or different than the advertisement 21 that is on the top side.

Materials of which the panel 20 can be constructed include, without limitation, plastic, vinyl, rubber, paper, cardboard, wood. The advertisement 21 can be a painting, a sticker, a decal, or all pressure sensitive materials, carpet fabrics, inks, plastisol, black or colored rubber that is properly secured to, painted on, or molded into or integrated into the panel 20.

The lamina 30 is preferably a transparent or substantially transparent piece of material. However, in some embodiments, the lamina 30 may be tinted with a color or some other design. Suitable materials for constructing the lamina 30 include, without limitation, plastic, vinyl, and films that are supported and unsupported, preferably with pressure sensitive adhesive. The main function of the lamina 30 is to protect the panel 20 from damage and/or wear without obstructing a customer's view of the advertisement 21. It should be noted that in some embodiments of the invention a lamina 30 may not be used or may be integrally formed into the panel 20 itself.

Referring still to FIG. 3, when assembled (as shown in FIGS. 1 and 4), the panel 20 is first inserted into the recessed area 17 with the advertisement 21 facing upward. The lamina 30 is then inserted atop the panel 20. The alignment of the panel 20 and the lamina 30 during assembly is indicated by the dotted arrows. When assembled properly, the floor advertising system 100 will be as illustrated in FIG. 1 (with the corner of the lamina laying flat).

Referring now to FIG. 4, which is a cross sectional view of the floor advertising system 100 taken along III-III of FIG. 1, the relative dimensions of the thickness t_{P} of the panel 20, the thickness t_{L} of the lamina 30, and the depth D of recessed area 17 will be discussed.

The recessed area 17 of the floor mat 10 has a depth D. In some embodiments of the invention it may be preferable that the nominal depth D be within a range of from about 0.0105 inches to about 0.25 inches, and most preferably about 0.125 inches. The panel 20 has a thickness t_{P}, which is preferred to be in the range of about 1.5 to about 4 millimeters. Similarly, the lamina 30 has a thickness t_{L}, which is preferred to be in the range of about 2 millimeters to 10 millimeters. The invention, however, is not limited to any particular dimension for the depth D of the recessed area 17, the thickness t_{P} of the panel 20, or the thickness t_{L} of the lamina 30.

As used herein, the term “about” means ±10%.

As also used herein, the articles “a”, “an”, and “the” refer to one or to more than one (i.e., to at least one) of the grammatical object of the article. By way of example, “an element” means one element or more than one element.

In some embodiments, it is preferred that the depth D of the recessed area 17 be substantially equal to the combined thickness of the panel 20 and the lamina 30, which is equal to t_{P}+t_{L}. This results in the floor advertising system 100 having a smooth/flush upper surface. In other embodiments, it may be preferred that the combined thickness t_{P}+t_{L} of the lamina 30 and the panel 20 be less than the depth D of the recessed area 17. By ensuring that the combined thickness t_{P}+t_{L} of the panel 20 and the lamina 30 is less than or substantially equal to the depth D of the recessed area 17, the panel 20 and/or lamina 30 are prohibited from protruding from the recessed area 17. Such protrusion is undesirable when it would create a lip or raised ledge on which a customer could trip and/or fall.

In embodiments of the present invention that either do not contain a lamina or have the lamina integrally formed into the panel 20, it may be preferable that the thickness t_{P} of the panel 20 itself be substantially equal to or less than the depth D of the recessed area 17. However, the invention is not so limited, and in other embodiments, the panel 20 and/or lamina 30 may protrude form the recessed area 17.

If desired, an adhesive can be applied to the back of the panel 20 and/or to the floor of the recessed area 17. The application of an adhesive will further ensure that the panel 20 does not slide out of the recessed area 17. The adhesive can be a special solvent removable adhesive, designed to adhere and/or remove from NBR, SBR, EPDM, Neoprene, CPE, Natural rubber or various combinations of the above. The adhesive can have a thickness tₐ of from about 0.5 to about 2 millimeters. In addition to an adhesive, other means can be used to secure the panel 20 within the recessed area 17, including, without limitation, double-sided tape, sewing, suturing, stapling, a tight-fit assembly, a flange assembly, or the like. Similar measures to secure the lamina 30 in place can also be taken. However, in some embodiments, no measures may be taken to secure the panel and/or lamina in place so that they can be easily removed and replaced as needed. When an adhesive or other means is used to secure the panel, the total thickness of the panel, lamina (if present), and adhesive (or other means) is preferably less than or substantially equal to depth D of the recessed area 17.

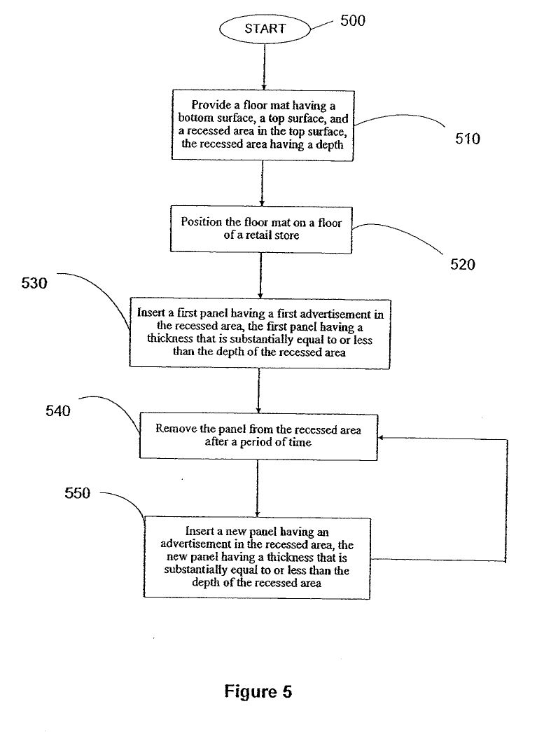

Referring now to FIG. 5, a method of advertising on the floor of a store according to an embodiment of the present invention is illustrated in a flow chart format. The method of FIG. 5 will be discussed in relation to the floor advertising system 100 of FIG. 1-4 for ease of discussion. As used herein, the term “floor” includes, without limitation, the interior floor of a store, the floor within an entranceway of a store, and the ground or pavement outside of a store.

The inventive advertising method starts at start block 500. At step 510, the floor mat 10 of FIG. 2 is provided. Depending on the situation, the floor mat 10 can be provided by a third party manufacture, by a store itself, by an advertiser, or by a company specializing in the coordination of advertisers and stores, such as FLOORgraphics®, Inc. Similarly, the floor mat 10 can be created a third party manufacture, by the store itself, by an advertiser, or by a company specializing in the coordination of advertisers and space providers.

Once the floor mat 10 is provided, the floor mat is positioned on the floor of a store, such as a retail store, wholesale store, club store, a grocery store, or the like (hereinafter referred to as a “space provider”), thereby completing step 520. There is no limitation on the location of the floor on which the floor mat 10 is positioned. For example, the floor mat 10 can be placed outside of the store, in an entranceway of the store, or in the store near the product to be advertised. The exact positioning of the floor mat 10 will be dictated by many considerations, including, without limitation, the advertiser's preference, the available floor space, the size of the floor mat 10, the amount of money paid by the advertiser, etc.

Once the floor mat 10 is positioned at the desired location on the floor, the panel 20 is inserted into the recessed area 17 of the floor mat 10 as shown in FIG. 3. The panel 20 is inserted into the recessed area 17 with the advertisement 21 facing upward so as to be visible by customers passing by, thus, completing step 530. In some embodiments of the invention, the lamina 30 may also be inserted into the recessed area atop the panel 20 at this time. As discussed above, adhesive or other connection means can be incorporated into these steps if desired.

After a period of time has passed, the panel 20 is removed form the recessed area 17, thereby completing step 540. The length of this period of time is dictated by a number of factors, including, without limitation, the estimated lifetime of the panel 20, the amount of money paid for by an advertiser, the term of an agreement, and/or the amount of wear the panel 20 has sustained.

At step 550, a new panel is inserted into the recessed area 17 of the floor mat 10 as described above. The new panel can be identical to the panel 20 except that it may contain a different advertisement. However, in some embodiments, the new panel may contain an advertisement identical to the one on the panel 20. Moreover, if the panel 20 was constructed so that it had an advertisement on both sides of the panel 20, step 550 can consist of merely flipping the panel 20 over and inserting it back into the recessed area 17 with the opposite side facing upward.

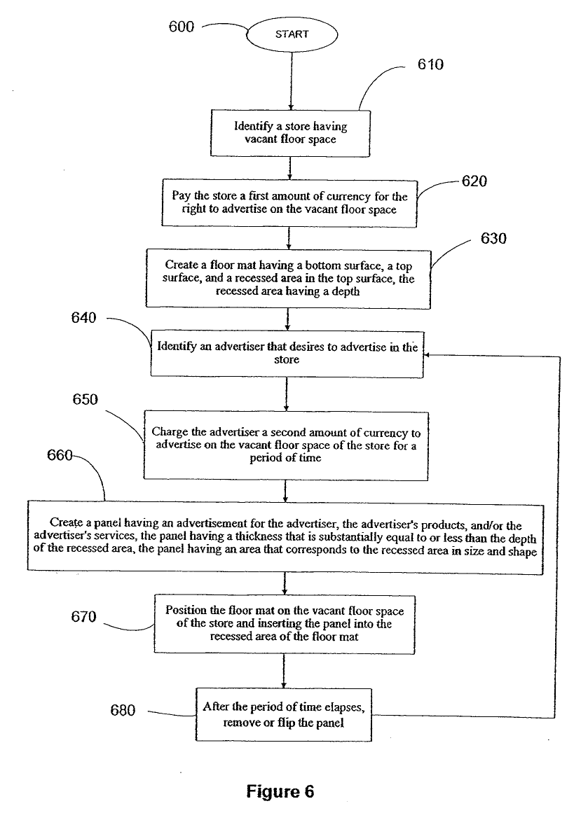

Turning now to FIG. 6, a method of doing business according to the present invention is exemplified. The method of FIG. 6 will be discussed in relation to the floor advertising system 100 of FIG. 1-4 for ease of discussion.

At step 610, a company specializing in the coordination of advertisers and space providers, such as FLOORgraphics®, Inc. (hereinafter referred to as “the controller”), identifies a store (i.e., a space provider) that has vacant floor space. Once a space provider is identified, the controller pays the space provider an amount of currency/money for rights to the vacant floor space, thereby completing step 620. The controller can lease the rights to the vacant floor space for six months, a year, or any other period of time. Preferably, in some embodiments, the period of time will be an extended period of time. The controller can pay the space provider in one lump sum payment or in a series of payments over time.

At step 630, a floor mat 10, such as the one illustrated in FIG. 2, is provided. The floor mat 10 can be created/provided by the controller, by a third party manufacturer, or by the space provider itself. The floor mat 10 is created so as to be an area that fits within the vacant floor space that was leased by the controller.

At step 640, which can be performed prior to step 630 if desired, the controller identifies an advertiser that desires to advertise on the floor space of the space provider identified in step 610. Once such an advertiser is identified, the controller charges the advertiser an amount of money/currency to advertise on the leased floor space for a period of time, completing step 650. In some embodiments, the controller will rent/sub-lease the floor space it leased from the space provider to the advertiser for a period of time that is a fraction of the time which the controller leased the space from the space provider, such as 2-4 weeks.

At step 660, the controller then provides a panel 20, such as the one shown in FIG. 3, having an advertisement 21 for the advertiser, the advertiser's products, and/or the advertiser's services. In some embodiments, the panel 20 can be created by the controller, a third party manufacturer, or the advertiser. The advertisement 21 on the panel 20 can be designed by the controller, at the direction of the controller, by a third party, by the advertiser, or at the direction of the advertiser.

Once created and provided, the panel 20 (which contains the advertisement 21) is inserted into the recessed area 17 of the floor mat 10, and the floor advertising system 100 is positioned on the vacant floor space of the space provider, thereby completing step 670. At step 680, once the period of time for which the advertiser has paid for its advertisement to exist on the floor space has elapsed, the panel 20 is removed from the floor mat 10 and the process returns to step 640. In embodiments of the invention where the panel is created so as to have an advertisement on both sides of the panel, step 680 may merely require that the panel be flipped over and inserted back into the recessed area 17 of the floor mat 10 with the opposite side facing upward.

Of course, the panel 20 can be replaced, cleaned, and/or otherwise maintained as needed by the controller or the space provider. As discussed above, the lamina 30 can be incorporated if desired into any of the aforementioned methods.

While the invention has been described and illustrated in detail, various alternatives and modifications will become readily apparent to those skilled in the art without departing from the spirit and scope of the invention.

What is claimed is:

1. A method of floor advertising comprising in a space provider comprising:
a) providing a floor mat having a bottom surface, a top surface, and a recessed area in the top surface, the recessed area having a depth;
b) inserting a first panel having a first advertisement in the recessed area; and
c) positioning the floor mat on a floor of the space provider

2. The method of claim 1 wherein the first panel has a thickness that is substantially equal to or less than the depth of the recessed area.

3. The method of claim 2 further comprising:
d) removing the first panel having the first advertisement from the recessed area after a period of time; and
e) inserting a second panel having a second advertisement in the recessed area, the second panel having a thickness that is substantially equal to or less than the depth of the recessed area.

4. The method of claim 1 further comprising:
f) inserting a lamina having a thickness in the recessed area and atop the panel, wherein a combined thickness of the lamina and the first panel is substantially equal to or less than the depth of the recessed area.

5. The method of claim 4 further comprising:
wherein the top surface of the floor mat comprises an advertising section and a scraping section, the recessed area being located within the advertising section;
wherein the scraping section comprises a plurality of scrapers for removing debris and/or dirt from shoes;
a containment trough surrounding the scraping section;
wherein the lamina is substantially transparent
wherein the floor mat is made of rubber;
wherein the recessed area comprises a containment ledge surrounding the entirety of the recessed area;
wherein the top surface of the floor mat is textured; and
wherein the first and second panel corresponds to the recessed area in size and shape.

6. A method of doing business comprising:
a) identifying a space provider having vacant floor space;
b) paying the space provider a first amount of currency for rights to the vacant floor space;
c) providing a floor mat having a bottom surface, a top surface, and a recessed area in the top surface, the recessed area having a depth, the floor mat having being of an area that fits within the vacant floor space;
d) identifying an advertiser that desires to advertise at said space provider;
e) charging the advertiser a second amount of currency to advertise on the vacant floor space of the space provider;
f) providing a panel having an advertisement for the advertiser, the advertiser's products, and/or the advertiser's services; and
g) positioning the floor mat on the vacant floor space of the space provider and inserting the panel into the recessed area of the floor mat.

7. The method of claim 6 wherein the panel has a thickness that is substantially equal to or less than the depth of the recessed area, the panel corresponding to the recessed area in size and shape.

8. The method of claim 7 wherein the thickness of the panel is substantially equal to the depth of the recessed area.

9. The method of claim 6 further comprising;
h) providing a lamina that corresponds in size and shape to the recessed area; and
i) inserting the lamina into the recessed area of the floor mat and atop the panel, wherein a combined thickness of the lamina and the panel is substantially equal to or less than the depth of the recessed area.

10. The method of claim 9 wherein the combined thickness is substantially equal to the depth of the recessed area and the lamina is substantially transparent.

11. A method of floor advertising comprising:
providing a floor mat having a bottom surface, a top surface, and a recessed area in the top surface, the recessed area having a first advertisement in the recessed area, for positioning on a floor of a space provider.

12. The method of claim 11 further comprising:
replacing the first panel having the first advertisement from the recessed area after a period of time with a second panel having a second advertisement, the second panel having a thickness that is substantially equal to or less than the depth of the recessed area.

13. A method of doing business comprising:
a) acquiring rights to vacant floor space in a space provider for advertising;
b) providing a floor mat having a bottom surface, a top surface, and a recessed area in the top surface, the floor mat having an area that fits within the vacant floor space, wherein said floor mat is positioned in said vacant floor space; and
c) providing a panel having an advertisement for an advertiser's products, and/or services to be placed in the recessed area of the floor mat.

14. The method of claim 13 further comprising
d) providing a lamina that corresponds in size and shape to the recessed area to be inserted into the recessed area of the floor mat and atop the panel, wherein a combined thickness of the lamina and the panel is substantially equal to or less than the depth of the recessed area.
